(19) United States
(12) Patent Application Publication
(10) Pub. No.: US 2012/0235428 A1
(43) Pub. Date: Sep. 20, 2012

(54) DEVICE FOR PREVENTING UNAUTHORIZED OPENING OF A DOOR

(76) Inventors: MARC A. BLACKLAWS, SPRUCE GROVE (CA); CHRIS W. ANDERSEN, CHEMAINUS (CA)

(21) Appl. No.: 13/420,423

(22) Filed: Mar. 14, 2012

(30) Foreign Application Priority Data
Mar. 14, 2011 (CA) 2733830

(51) Int. Cl. E05C 19/00

(52) U.S. Cl. 292/338

(57) ABSTRACT

A device for preventing unauthorized opening of a door is disclosed comprising: a bracket for mounting against a side wall of a door; a brace connected to the bracket and having a ground engaging end and a lock end, the brace being biased into an unbraced position; and a release lever connected to the bracket and having a pedal surface and a lock surface; the device having in use a braced position in which the ground engaging end contacts a ground surface and the lock end of the brace is engaged by the lock surface of the release lever to prevent the brace from moving into the unbraced position, the release lever being biased into the braced position; the release lever being movable, by application of force against the pedal surface, into a disengaged position in which the lock surface disengages the lock end of the brace to allow the brace to move into the unbraced position.

### TECHNICAL FIELD

This document relates to devices for preventing unauthorized opening of a door.

### BACKGROUND

Generally, an access door may be closed and locked in order to secure an area that is occupied or unoccupied. Conventional key locks are used to maintain a door in a closed position. In some cases, a door may have multiple locks to add redundant protection to a door.

A door stop may also be used to secure a door from unauthorized entry. A door stop may incorporate a brace that extends downwardly from the inside of the door in order to brace against the ground or floor and prevent the door from being opened from the other side of the door. The brace may be released by a user to allow the door to be opened.

### SUMMARY

A device for preventing unauthorized opening of a door is disclosed, the device comprising: a bracket for mounting against a side wall, such as an inside facing side wall, of a door; a brace connected to the bracket and having a ground engaging end and a lock end, the brace being biased into an unbraced position; and a release lever connected to the bracket and having a pedal surface and a lock surface, such as a lock surface mechanism; the device having in use a braced position in which the ground engaging end contacts a ground surface and the lock end of the brace is engaged by the lock surface of the release lever to prevent the brace from moving into the unbraced position, the release lever being biased into the braced position; the release lever being movable, by application of force against the pedal surface, into a disengaged position in which the lock surface disengages the lock end of the brace to allow the brace to move into the unbraced position.

A device for preventing unauthorized opening of a door is also disclosed, the device comprising: a door with a side wall such as an inside facing side wall; a brace connected to the side wall and having a ground engaging end and a lock end, the brace being biased into an unbraced position; and a release lever connected to the side wall and having a pedal surface and a lock surface, such as a lock surface mechanism; the device having in use a braced position in which the ground engaging end contacts a ground surface and the lock end of the brace is engaged by the lock surface of the release lever to prevent the brace from moving into the unbraced position, the release lever being biased into the braced position; the release lever being movable, by application of force against the pedal surface, into a disengaged position in which the lock surface disengages the lock end of the brace to allow the brace to move into the unbraced position.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIGS. 1A-D are a series of side elevation views that illustrate the operation of an embodiment of a device. The bracket connecting the device to the door, and the inner connection between the resilient foot and the brace, are both illustrated with ghost lines.

FIG. 2 is a front elevation view of the device of FIGS. 1A-D in combination with a magnetic stopper mounted against an adjacent wall.

FIG. 3 is a front elevation view of a controller for operating a device.

FIG. 4 is a side elevation view of the controller of FIG. 3 positioned to operate a device, which is shown in ghost lines.

FIG. 5 is a front elevation view of the controller of FIG. 3 adapted for remote operation and with the cover removed to illustrate the interior components.

FIG. 6 is a side elevation view of another embodiment of a device. The bracket connecting the device to the door is illustrated in ghost lines.

### DETAILED DESCRIPTION

Immaterial modifications may be made to the embodiments described here without departing from what is covered by the claims.

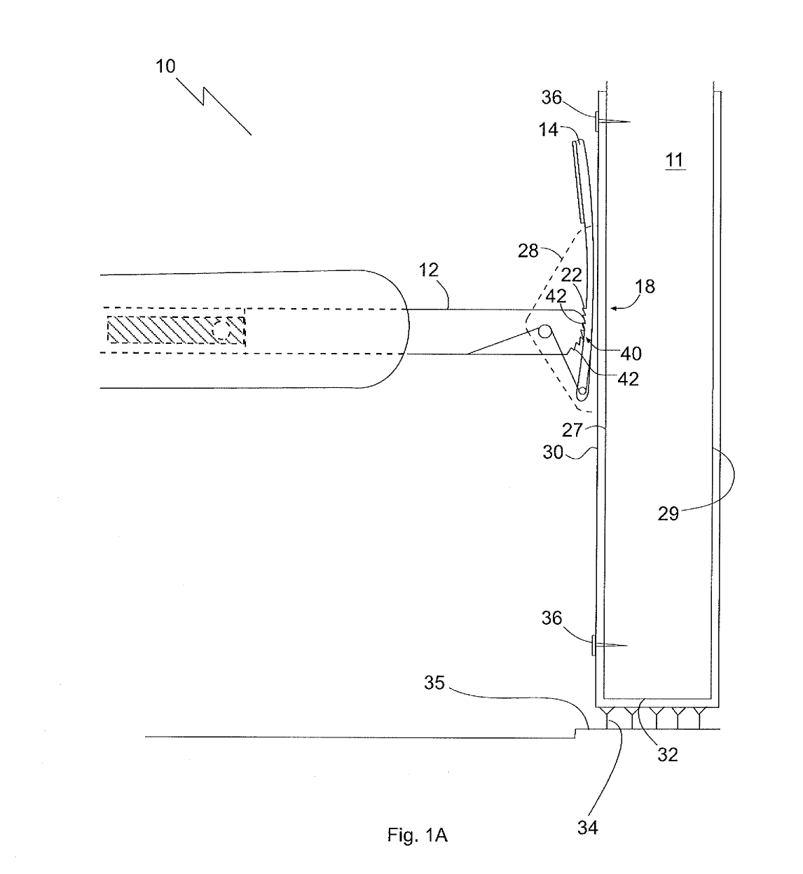

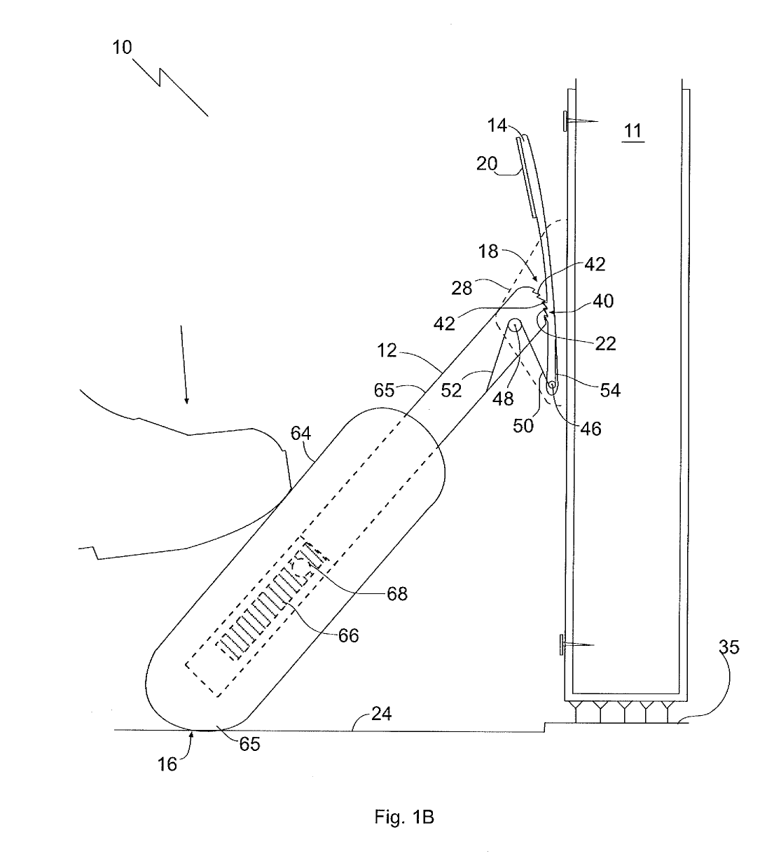

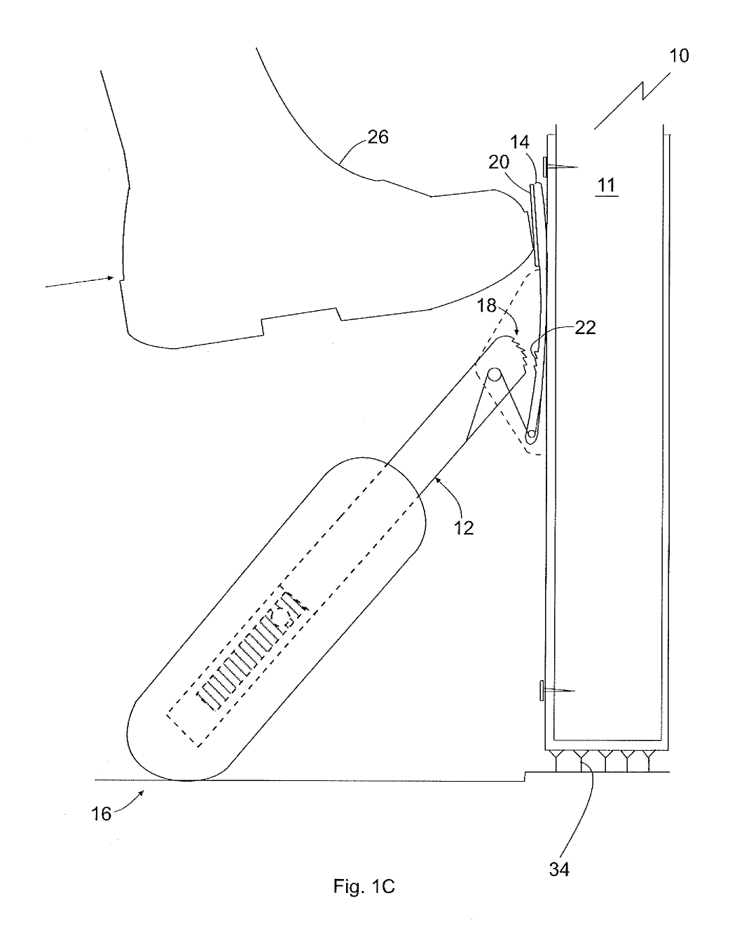

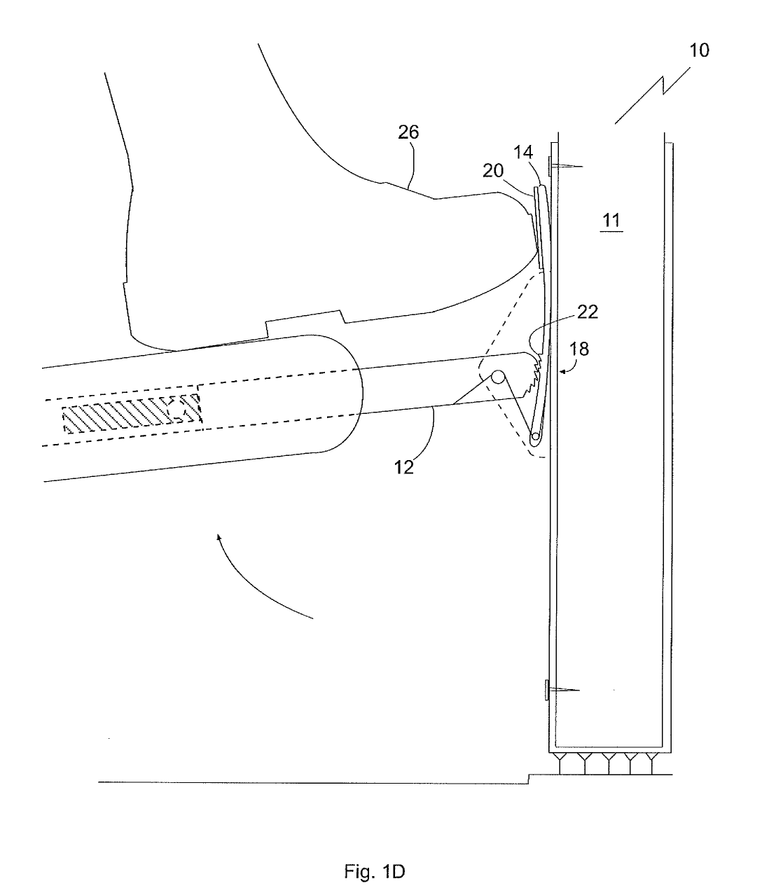

Referring to FIGS. 1A-D, a device 10 for preventing unauthorized opening of a door 11 is illustrated comprising a brace 12 and a release lever 14. FIG. 1C illustrates that brace 12 has a ground engaging end 16 and a lock end 18. In addition, the release lever 14 has a pedal surface 20 and a lock surface 22. FIGS. 1A and 1D illustrate that the brace 12 is biased into an unbraced position as shown. FIG. 1B illustrates the device 10 in a braced position. The operation of the device 10 will now be described generally. Referring to FIGS. 1A-B, the brace 12 is movable from the unbraced position (FIG. 1A) to the braced position (FIG. 1B) as shown. In use in the braced position (FIG. 1B), the ground engaging end 16 contacts a ground surface 24, which may be a mat layer or a floor, and the lock end 18 of the brace 12 is engaged by the lock surface 22 of the release lever 14 to prevent the brace 12 from moving into the unbraced position (FIG. 1A). The release lever 14 is also biased into the braced position (FIG. 1B), and thus once the brace 12 is in place, lock surface 22 maintains locking contact with brace 12 and ensures that the door 11 remains braced. Referring to FIGS. 1C-D, the release lever 14 is movable, by application of force, for example by a user's foot 26, against the pedal surface 20, into a disengaged position (FIG. 1C) in which the lock surface 22 disengages the lock end 18 of the brace 12 to allow the brace 12 to move into the unbraced position (FIG. 1D).

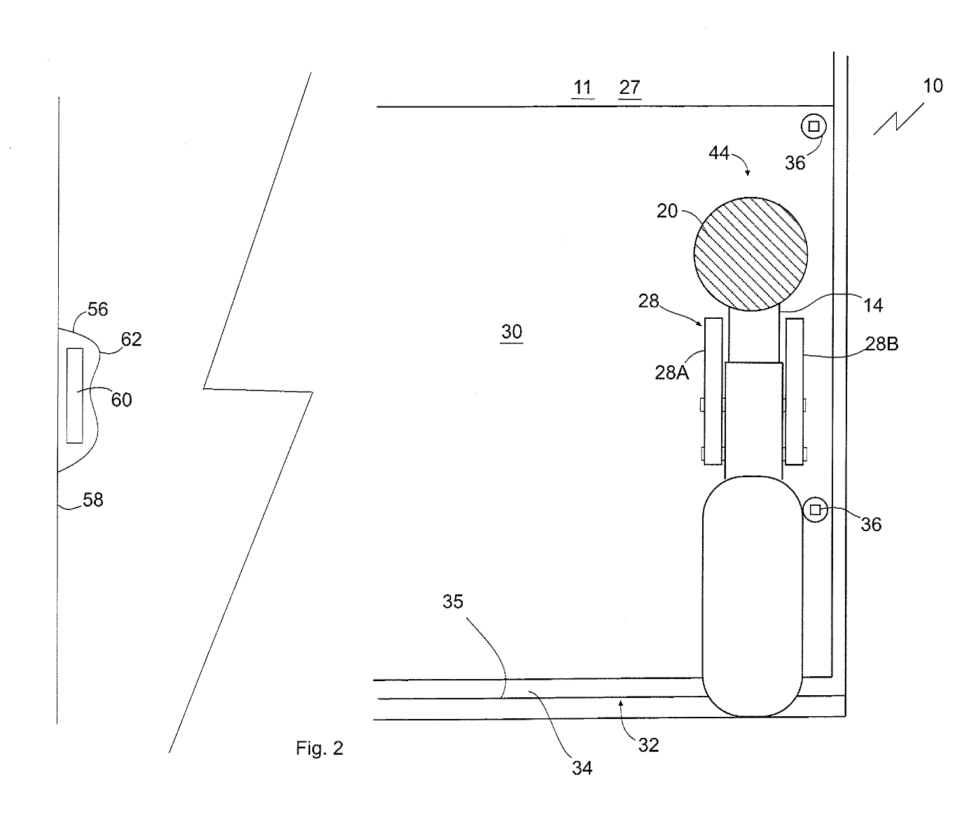

Referring to FIG. 1A, the brace 12 and release lever 14 are adapted for mounting against a side wall such as an inside facing side wall 27 of door 11. Mounting may be achieved through the use of a bracket 28 (illustrated in ghost lines). For example, brace 12 and release lever 14 are illustrated as being connected, for example pivotally connected as shown, to the bracket 28. The bracket 28 may be a frame that houses pivot shafts (not shown) for the rotating parts such as brace 12 and lever 14. Referring to FIG. 2, a front view of bracket 28 illustrates that more than one bracket 28 may be used, for example cooperating brackets 28A and 28B as shown. Lever 14 and brace 12 are illustrated as being attached to both brackets 28A and 28B. In some embodiments the lever 14 may be attached to a first bracket (not shown) and the brace 12 attached to a second bracket (not shown). A cover (not shown) may be provided for the device 10, for example to protect the various components such as the bracket 28 and ratchet 40 (see below) from damage.

Referring to FIGS. 1A and 2, bracket 28 may further comprise a U bracket 30 adapted for fitting under a base 32 of door 11 and around opposed sidewalls 27, 29 of the door 11. Weather stripping 34 may be provided around door 11. The door 11 may rest above a door sill 35. Screws 36 or other fasteners (not shown) may be used to secure U bracket 30 to door 11. Although U bracket 30 is illustrated, it should be understood that in some embodiments (not shown) bracket 28 may be attached directly to door 11. In other embodiments (not shown) brace 12 and release lever 14 may be directly connected to door 11. For example, side wall 27 of an existing door 11 may be profiled or indented such that brace 12 and release lever 14 may fit and be installed at least partially within the resulting profile or indent in door 11. Positioning device 10 within an indent or profile in the door 11 has the advantage of minimizing the external space taken up by the device 10.

Referring to FIGS. 1A-B, the lock end 18 and the lock surface 22 of release lever 14 may form a ratchet 40. Thus, ratchet 40 allows the user's foot 26 to swing brace 12 downwardly into the braced position (FIG. 1B). Once in the braced position (FIG. 1B), ratchet 40 prevents brace 12 from biasing in the opposite direction into the unbraced position (FIG. 1A) as long as ratchet 40 is engaged. In the embodiment shown, both lock surface 22 and lock end 18 comprises one or more corresponding ratchet teeth 42. However, other types of ratchet are possible such as a pawl and gear arrangement (not shown). Ratchet 40 may be designed to minimize backlash to reduce the chance that the ground engaging end 16 may inadvertently lose contact with the ground surface 24.

Referring to FIG. 1C and 2, device 10 may be installed or designed such that the pedal surface 20 is positioned for foot operation in use. Referring to FIG. 2, pedal surface 20 is shown as a round surface for example at a lever end 44 of release lever 14, although other suitable shapes may be used. Pedal surface 20 may be smooth and flat (FIG. 1A), or may be textured or contoured as desired (not shown).

Referring to FIG. 1B, when in the braced position the release lever 14 may be spaced from the door 11 and positioned between the lock end 18 and the door 11. Thus, there is sufficient room to allow release lever 14 to be contacted and moved a distance towards door 11 sufficient to disengage lock surface 22 and lock end 18 (FIG. 1C). Of course, it is not required that the entire release lever 14 be spaced from door 11, but at least the portion of the lever 14 that holds the lock surface 22 must be spaced from the door 11 in these embodiments.

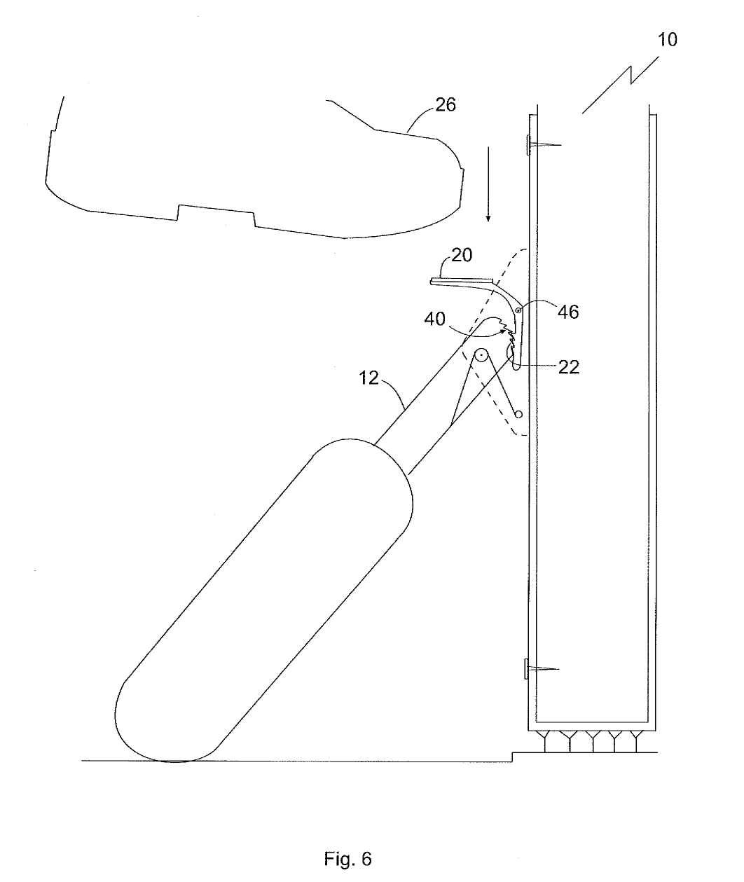

As disclosed above, the connection between the bracket 28 and both the release lever 14 and brace 12 may be a pivotal connection. Referring to FIG. 1B, for example the release lever 14 is pivotally connected to the bracket 28 about a release lever pivot axis 46, and the brace 12 is pivotally connected to the bracket 28 about a brace pivot axis 48. In the embodiment shown the lock surface 22 of the release lever 14 is positioned between the pedal surface 20 and the release lever pivot axis 46. However, other arrangements may be used, such as the arrangement shown in FIG. 6 where the release lever pivot axis 46 is between the pedal surface 20 and the lock surface 22. In the embodiment of FIG. 6, downward force, for example by a user's foot 26 as shown, against pedal surface 20 acts to pivot the release lever 14 and disengage the ratchet 40, allowing the device 10 to reset. By contrast, in FIG. 1B, pedal surface 20 faces in a horizontal direction and requires a horizontally directed force to reset. Other arrangements may be used, for example the pedal surface 20 may be positioned below or to the side of the pivot axis 46 and the pedal surface 20. In addition, the pedal surface 20 may be between the pivot axis 46 and the pedal surface 20.

The biasing of brace 12 and release lever 14 may be achieved by suitable bias devices. For example, referring to FIG. 1B, a clip spring 50 may be connected between the release pivot axis 46 and the brace pivot axis 48 for biasing the brace 12 into the unbiased position and the release lever 14 into the braced position. Clip spring 50 is drawn with a brace end 52 and a lever end 54 extending past respective pivot axes 48 and 46. Ends 52 and 54 may connect to respective stops (not shown) on brace 12 and lever 14, respectively. In other examples (not shown), curled springs, gas compression, and material resiliency may be used as bias mechanisms.

Referring to FIG. 2, device 10 may be used in combination with a stopper 56 for mounting against a wall 58 adjacent the door 11 to prevent damage of the wall 58 from contact with the device 10 upon opening of the door 11. The positioning of the stopper 56 on wall 58 depends on how the brace 12 extends when in the unbraced position, so that the stopper 56 aligns with the released brace 12 as the door 11 is swung open. It should be understood that the unbraced position may refer to more than one position, for example any position along the range of positions between closed to fully open. In one embodiment (FIG. 1A) the brace 12 is adapted to extend substantially horizontally when in the unbraced position. This may be achieved by restricting upwards movement past horizontal of brace 12 through mechanical means such as a stop (not shown). Referring to FIG. 2, both the brace 12 and stopper 56 may be magnetically attracted to one another to hold the door in an open position. For example, brace 12 and stopper 56 may comprise ferromagnetic material 60 (not shown for the brace 12). The ferromagnetic material 60 may be protected by an external coating of protective material such as rubber 62.

Referring to FIG. 1B, the ground engaging end 16 of brace 12 may comprise a resilient foot 64, for example made of rubber. The use of a resilient foot allows brace 12 to be ratcheted tightly into the braced position by compressing a floor-contacting portion 65 of foot 64 to compensate for ratchet backlash. The resilient foot 64 may be threaded to a stem 65 of the brace 12 for example using cooperating threading 66 between stem 65 and foot 64. Thus, the length of the brace 12 may be adjustable to accommodate installation to different floor heights. Other suitable mechanisms may be used for adjusting the length of brace 12 such as by providing brace 12 in telescoping pieces (not shown). In the embodiment shown in FIG. 1B, after the appropriate length of brace 12 is provided by threading the foot 64 to stem 65, a fastener such as a set screw 68 may be used to secure the foot 64 to the stem 65 at that length.

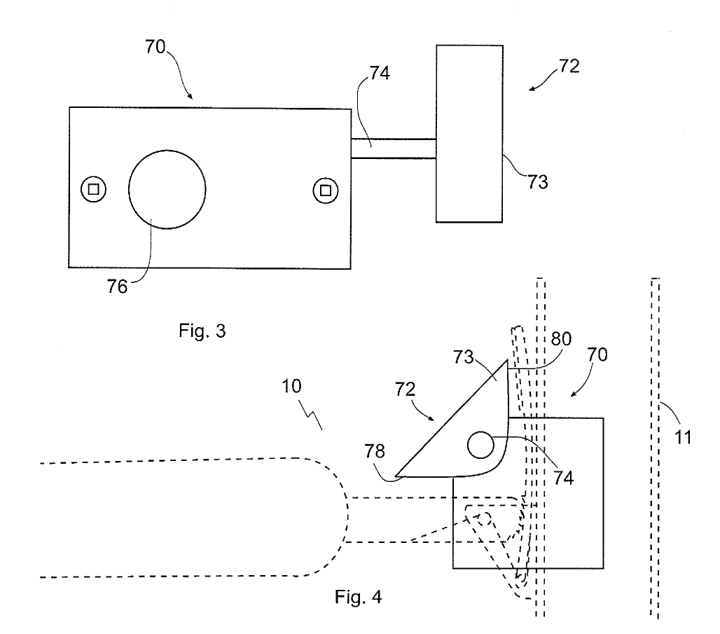

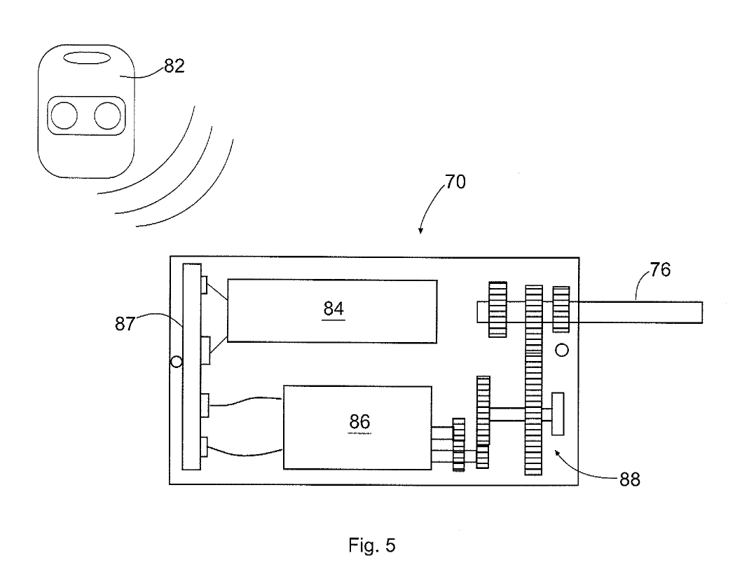

Referring to FIGS. 3-5, a controller 70 may be used to operate device 10 (shown in FIG. 4). For example, controller 70 may be connected to operate an actuator 72 (FIGS. 3 and 4) for moving the device 10 into the braced position and for moving the release lever 14 into the disengaged position. Actuator 72 may comprise a cam 73 connected to a drive shaft 74 extending from controller 70. The cam 73 is illustrated as being positioned to operate a device 10 similar to the device of FIG. 1. When the controller 70 is instructed, for example by pressing a button 76 (FIG. 3) on controller 70, to brace the door 11, controller 70 may rotate drive shaft 74 causing cam 73 to rotate counter-clockwise for the embodiment shown. Counter-clockwise motion allows a brace arm 78 of cam 73 to contact brace 12 and swing brace 12 downwardly into the braced position. When the controller 70 is instructed to unbrace the door 11, controller 70 may rotate shaft 74 clockwise until a release arm 80 of cam 73 contacts pedal surface 20 of release lever 14 to cause brace 12 to unbrace. Referring to FIG. 5, the controller 70 may be operable by remote control, for example by operation of a key chain radio transmitter 82, external keypad (not shown), a cell phone (not shown), or other suitable wireless device. Thus, device 10 may be used to brace door 11 even when a user is on the opposite side of door 11 (FIG. 4). Controller 70 may include a power source 84 such as one or more AA batteries or a wall outlet connection, a circuit board 87 (including RF receiver, not shown), a servo motor 86, and associated gearing 88 connected to drive shaft 76. Other components may be provided as needed.

Referring to FIG. 1B, the device 10 may be retrofitted to an existing door 11, or may be installed on a new door. Device 10 may be provided in kit form, or may be provided fully installed on a new door 11. Device 10 may be used on any suitable type of door including rotating doors, hinged doors, french doors, and swinging doors (such as dog doors).

Neither the release lever 14 nor the brace 12 need to be pivotally connected to the bracket 28 or door 11. For example, either or both the release lever 14 and the brace 12 may be slidably connected, or may be rigidly connected but resiliently movable. An example of a further embodiment (not shown) provides the release lever 14 as a resilient tab and the brace 12 mounted to slide (not swing) downwards into position.

The brace 12 and release lever 14 may be straight, curved, or other suitable shapes as desired. One or more brace 12 may be present on the device 10. Embodiments of the devices 10 disclosed herein may be referred to as door stops. In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

1. A device for preventing unauthorized opening of a door, the device comprising:
a bracket for mounting against a side wall of the door;
a brace connected to the bracket and having a ground engaging end and a lock end, the brace being biased into an unbraced position; and
a release lever connected to the bracket and having a pedal surface and a lock surface;
the device having in use a braced position in which the ground engaging end contacts a ground surface and the lock end of the brace is engaged by the lock surface of the release lever to prevent the brace from moving into the unbraced position, the release lever being biased into the braced position;
the release lever being movable, by application of force against the pedal surface, into a disengaged position in which the lock surface disengages the lock end of the brace to allow the brace to move into the unbraced position.

2. The device of claim 1 in which the lock end and the lock surface form a ratchet.

3. The device of claim 1 in which the pedal surface is positioned for foot operation in use.

4. The device of claim 1 in which the bracket further comprises a U bracket adapted for fitting under a base of a door and around opposed sidewalls of the door.

5. The device of claim 1 in which in the braced position the release lever is spaced from the door and positioned between the lock end of the brace and the door.

6. The device of claim 1 in which the release lever is pivotally connected to the bracket about a release lever pivot axis, and the lock surface of the release lever is positioned between the pedal surface and the release lever pivot axis.

7. The device of claim 1 in combination with a stopper for mounting against a wall adjacent the door to prevent damage of the wall adjacent the door from contact with the device upon opening of the door.

8. The device of claim 7 in which both the brace and stopper are magnetically attracted to one another for holding the door in an open position.

9. The device of claim 1 in which the ground engaging end comprises a resilient foot.

10. The device of claim 9 in which resilient foot is threaded to the brace.

11. The device of claim 1 in which the length of the brace is adjustable.

12. The device of claim 1 in which the release lever is pivotally connected to the bracket about a release lever pivot axis, the brace is pivotally connected to the bracket about a brace pivot axis, and further comprising a clip spring connected between the release pivot axis and the brace pivot axis for biasing the brace into the unbiased position and the release lever into the braced position.

13. The device of claim 1 further comprising a controller connected to operate an actuator for moving the device into the braced position and for moving the release lever into the disengaged position.

14. The device of claim 13 in which the controller is operable by remote control.

15. The device of claim 1 in which the brace is adapted to extend substantially horizontally when in the unbraced position.

16. The device of claim 1 in which the side wall is an inside facing side wall of the door.

17. A device for preventing unauthorized entry opening of a door, the device comprising:
a door with a side wall;
a brace connected to the side wall and having a ground engaging end and a lock end, the brace being biased into an unbraced position; and
a release lever connected to the side wall and having a pedal surface and a lock surface;
the device having in use a braced position in which the ground engaging end contacts a ground surface and the lock end of the brace is engaged by the lock surface of the release lever to prevent the brace from moving into the unbraced position, the release lever being biased into the braced position;
the release lever being movable, by application of force against the pedal surface, into a disengaged position in which the lock surface disengages the lock end of the brace to allow the brace to move into the unbraced position.
